(19) United States
(12) Patent Application Publication
(10) Pub. No.: US 2005/0031104 A1
(43) Pub. Date: Feb. 10, 2005

(54) Telephone apparatus

(76) Inventors: Muhammad Farid Ridhwan, Kuala Lumpur (MY); Rajendran Velayuthan, Selangor (MY); Siti Sakinah Mohamed Noh, Selangor (MY); Juhari Zambri, Kulim Kedah (MY); Mohd Firdaus Hj Shuib, Selangor (MY); Simon Johannes Van Der Stoel, Veldhoven (NL)

Correspondence Address: BACON & THOMAS, PLLC, 625 SLATERS LANE, FOURTH FLOOR, ALEXANDRIA, VA, 22314, US

(21) Appl. No.: 10/492,527

(22) PCT Filed: Oct. 23, 2002
(86) PCT No.: PCT/SG02/00246

(30) Foreign Application Priority Data
Oct. 24, 2001 (MY) 2001-49 42

(51) Int. Cl. H04M 15/00; H04M 1/56; H04M 15/06

(52) U.S. Cl. 379/114.07; 379/114.01; 379/142.17

(57) ABSTRACT

The present invention relates to a telephone apparatus comprising of a chip card receiver (28) for identification purpose, a display unit (30) and a circuitry to send and/or receive appropriate signals to a remote server wherein the said apparatus is only line powered; the said circuitry further comprises a CAS receiving means to acknowledge the phone is in offhook state and accordingly to mute the receiver, microphone and is able the keypad; a DTMF generator means to send appropriate DTMF signal to a remote server; a FSK signal receiving means and means to convert and display said signal on display unit (30); a chip card reader to receive an external chip card and sending the data within the said card to the said remote server; means to enable keypad and unmute receiver and microphone when there is balance in the user's account to allow the user to dial the intended number.

### FIELD OF INVENTION

The present invention relates to a telephone apparatus for prepayment of telephone call charges. More particularly, it relates to a telephone apparatus comprising of a chip card receiver for identification purpose, a display unit and a circuitry to send and/or receive appropriate signals to a remote server wherein the said apparatus is only line powered.

### BACKGROUND OF THE INVENTION

Presently, normal fixed telephones that only have the basic telephone functions is powered only by means of the telephone line. However more elaborate telephones which have display units and a card reading means normally require additional power supply to run the added peripherals. The additional power supply is in the form of an adapter unit or batteries. One manner of eliminating the said additional power supply is by incorporating an auxiliary charging capacitor to the circuit.

Therefore the present invention aims to eliminate the use of any additional power supply apart from that from the telephone line wherein the present telephone apparatus includes a display unit, card reader and a circuitry capable of receiving CAS and FSK signals and generating DTMF signals in order to have the telephone as means to receive a prepaid card and sending the data within the prepaid card to a remote server for verification purpose accordingly allowing the user to make a call and further more displaying the balance within the users account.

### SUMMARY OF THE INVENTION

It has now been provided an improved telephone apparatus. Thus in accordance with a first embodiment of the invention a telephone apparatus which includes a chip card reader, a display unit (30) and a circuitry for sending the data of the card to a remote server and receiving appropriate signals from the said server in order to enable the user to make a call if there is balance in the user's account stored at the remote server whereby the said telephone is only line powered; the said circuitry further comprises a CAS receiving means to acknowledge the phone is in off hook state and accordingly to mute the receiver, microphone and disable the keypad; a DTMF generator means to send appropriate DTMF signal to a remote server; a FSK signal receiving means and means to convert and display said signal on display unit (30); a chip card reader to receive an external chip card and sending the data within the said card to the said remote server; means to enable keypad and unmute receiver and microphone when there is balance in the user's account to allow the user to dial the intended number.

### BRIEF DESCRIPTIONS OF THE INVENTION

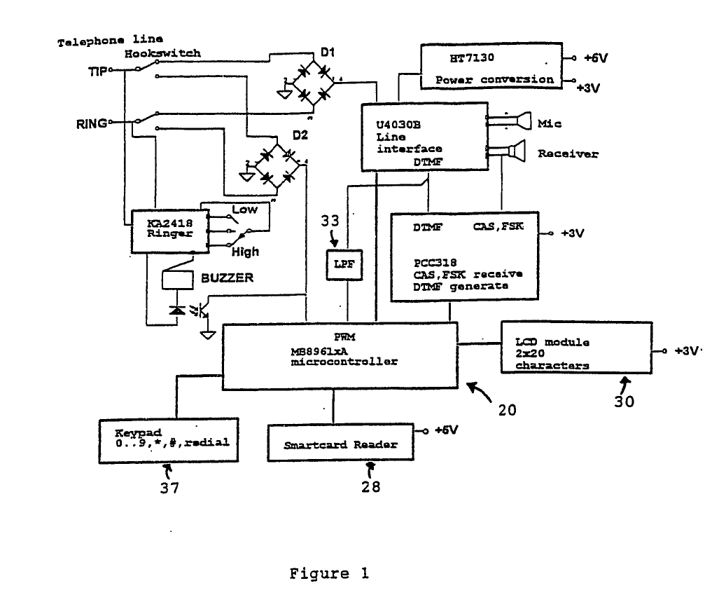

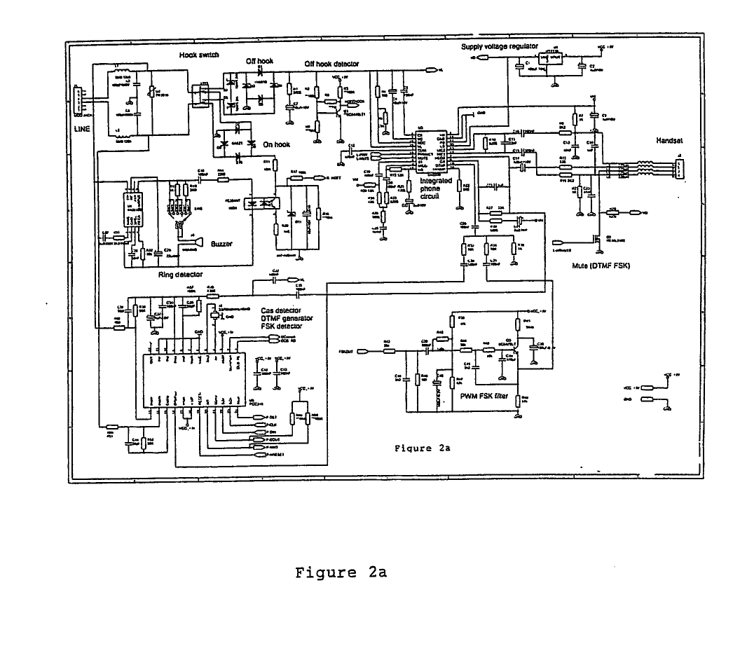

FIG. 1 illustrates the block diagram of present invention.

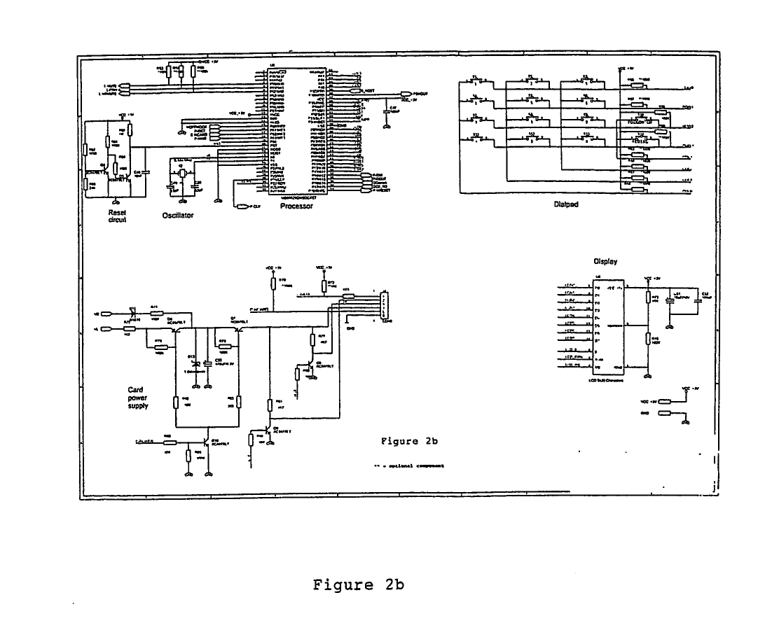

FIGS. 2a & 2b shows the circuit diagram of the preferred embodiment.

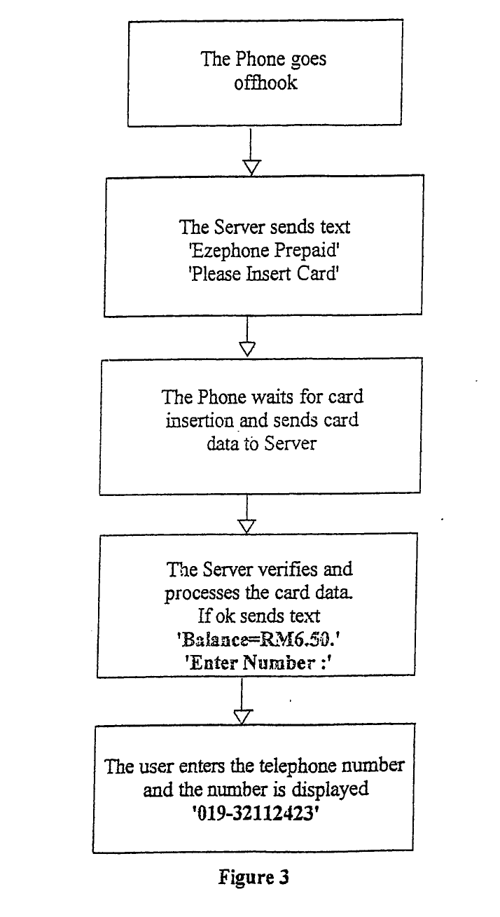

FIG. 3 shows an example of the typical communication sequence of the telephone in off hook state.

### DETAILED DESCRIPTION OF THE INVENTION

According to FIG. 1 when the phone is in off hook state that is when the handset is lifted, the power from the line flows through full wave bridge rectifier circuit (D1) which consist of 4 diodes. Schottky diodes are used to have low voltage drop in order to get maximum power from the telephone line (32). At this stage a remote server detects the phone in off hook condition and sends a CAS (Call Alert Signal) tone. The manner the server detects and returns signals will not be explained as it is beyond the scope of the present invention. The said diodes are connected to a filter circuit (14) comprising a resistor and a capacitor. An off-hook detector (16) made up of a switching circuit comprising a transistor is connected in parallel to the filter circuit (14). The output of the switching circuit is fed to the microcontroller (20) so that the microcontroller (20) detects the phone is in off hook. When the phone is in off hook state the Intergrated phone circuit is in active state where line voltage VL activates it. It should be noted that the telephone according to the present invention may still work but less efficiently without the use of the filter circuit (14) and the switching circuit. In this embodiment, instead of using the output of the switching circuit, VL is fed to the microcontroller (20) to determine if the phone is off hook or not.

According to the preferred embodiment, once the CAS signal as mentioned earlier is received from the server it triggers an appropriate DTMF signal to be sent to the remote server as acknowledgement. At this stage the microcontroller (20) sends relevant signals to the Integrated phone circuit (25) switch to mute the receiver, microphone and disable the keypad (37). enable the cardreader. The microcontroller (20) receives the data sent from the server and displays the message on the LCD display unit (30). The oscillator circuit connected to the microcontroller is needed to guarantee the accuracy of the generating frequencies by the pulse width modulation (PWM) output. The low-pass filter (33) is used to convert the square wave PWM output of the microcontroller into a sine-wave FSK signal. Once the complete message is received and the checksum is fine, the DTMF generator sends appropriate DTMF tones as acknowledgment. The checksum is a means of identifying whether an erroneous message has been received. If the checksum is not okay the microcontroller (20) unmutes the microphone and receiver and enables the keypad and rejects the whole message.

After a short period around 100 ms after the transmission of the last DTMF tone a check is made where within the message to insert card is sent to the microcontroller (20), the microcontroller (20) unmutes the receiver but keeps the microphone muted and waits for card insertion. If the said message was not passed then the microcontroller (20) unmutes the microphone and receiver and enables the keypad. The telephone goes back to offhook state. The method of checking the validity of the received message is done by the software stored in the microcontroler.

If a message is not sent within a certain period the microcontroller (20) unmutes the microphone and receiver and enables the keypad. The message basically requests the user to insert the chip card. The user upon reading the message inserts the said chip card. The microcontroller (20) detects card insertion then reads the data stored in the card and disabled. A short period (in milliseconds) after the FSK transmission, the microcontroller (20) unmutes the microphone and receiver and enables the keypad, and the phone is in offhook state.

If the card is valid the phone receives the message in FSK transmission and displays it. The microcontroller (20) also receives keypad enable signal from the server to enable the keypad. The microcontroller (20) accordingly sends signal to the Integrated phone circuit (25) to enable the keypad and also to unmute the receiver and microphone.

The user upon looking at the display unit (30) requesting for a number to be inserted, keys in the desired number. The numbers are displayed on the display unit (30) for the convenience of the user. The keyed in digits are sent via DTMF tones to the server which forwards the call. As in any conventional phone when the line goes through the dialing tone ends and the user starts conversing. At this stage the microcontroller (20) receives messages at a predetermined interval from the server to display the amount left in the user's account. The manner in which the amount is decremented is done by the server unit and is beyond the scope of the present invention.

When the handset is placed on the hook the telephone is in on hook state where (D2) is connected to the power supplied by the telephone line (32). The phone has a conventional ringer circuit (34) connected to it. To detect a ringsignal an optocoupler (36) and said (D2) circuit is added. Instead of an optocoupler, other galvanic isolation means maybe used. The circuit is also extended with a sample and hold unit that signal for the last 5 seconds and also to determine if a call is incoming or outgoing.

The hook switch (38) is the only means of turning on the system from its power down mode.

The characteristics of the CAS signal are:

| | |
|---|---|
| Frequency Limits: | Lower tone: 2130 Hz +/− 0.5% |
| | Upper tone: 2750 Hz +/− 0.5% |
| Dynamic range: | −32 to −14 dBm per tone |
| Power differential within dynamic | 0-6 db between tones |
| range: | |
| Tone Duration: | 75 to 85 ms |

The characteristics of the DTMF tones are:
DTMF tones (send only) Frequency limits:
Low or Low Frequency tolerance: +/−0.5%
Power level (lower tone): −9.5+/−1 dB
Power level (upper tone): −7.5+/− dB
Tone duration: 55 to 65 ms

The physical characteristics of the FSK signal are:
Bell 202 1200 baud FSK (Frequency Shift keying) signals.
Modulation Type: Continues phase binary frequency shift keying
Mark (logical 1): 1200+/−12 Hz
Space (logical 0): 2200+/−22 Hz
Received Signal Level 1200 Hz: Between −32 dBm and −12 dBm
Received Signal Level 2200 Hz: Between −36 dBm and −12 dBm
Signal-to-distortion ratio: >=25 dB
Transmission rate: 1200+/−12 baud

It is to be noted that the drawings and description herein are merely to exemplified the invention and do not represent the only and whole range of embodiments of the invention which is capable of many combinations of methods and of the various embodiments' features described herein. Each of the feature described may be varied, modified or adapted by a person skilled in the art without departing from the working principle or spirit of the invention which scope is defined in the following claims.

1. A telephone apparatus which includes a chip card reader, a display unit and a circuitry for sending the data of the card to a remote server and receiving appropriate signals from the said server in order to enable the user to make a call if there is balance in the user's account stored at the remote server whereby the said telephone is only line powered;
the said circuitry further comprises a CAS receiving means to acknowledge the phone is in offhook state and accordingly to mute the receiver, microphone and disable the keypad;
a DTMF generator means to send appropriate DTMF signal to a remote server;
a FSK signal receiving means and means to convert and display said signal on display unit;
a chip card reader to receive an external chip card and send the data within the said card to the said remote server; and
means to enable keypad and unmute receiver and microphone when there is balance in the user's account to allow the user to dial the intended number.

2. A telephone apparatus as claimed in claim 1 wherein the message data to be displayed is received from the remote server via FSK signaling.
